(19) United States
(12) Patent Application Publication
(10) Pub. No.: US 2013/0279975 A1
(43) Pub. Date: Oct. 24, 2013

(54) FASTENING STRUCTURE ASSEMBLY

(71) Applicants: CHIN-SUNG YANG, Tu-Cheng (TW); WEI LIU, Shenzhen City (CN); XUE-DONG TANG, Shenzhen City (CN)

(72) Inventors: CHIN-SUNG YANG, Tu-Cheng (TW); WEI LIU, Shenzhen City (CN); XUE-DONG TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/459,108

(22) Filed: Apr. 28, 2012

(30) Foreign Application Priority Data
Apr. 20, 2012 (CN) 201210117539.6

(51) Int. Cl. F16B 7/18

(52) U.S. Cl. 403/343

(57) ABSTRACT

A fastening structure assembly includes a housing, a to-be-fixed element, and at least one fastening element. The housing defines at least one fastening post. The to-be-fixed element includes at least one supporter each of which is bent to surround one of the at least one fastening post. Each of the at least one fastening element includes a stopper and a fastening pole extending from the stopper. Each of the fastening pole engages with one of the fastening posts to make the corresponding stopper resist an edge of the supporter surrounding the fastening post to fasten the to-be-fixed element to the housing.

### BACKGROUND

1. Technical Field

The present disclosure relates to a fastening structure assembly, particularly to a fastening structure assembly to fasten a to-be-fastened element to a housing of an electronic device.

2. Description of Related Art

FIGS. 1-2 show a conventional fastening structure assembly 100 fastening a trim element 1 to a mirror housing 2. The mirror housing 2 defines a stud 21. The trim element 1 defines a supporter 10. The supporter 10 includes a supporting body 11 and a cover 12 fastened to the supporting body 11. The cover 12 defines a hole 13. A screw 3 passes through the hole 13 and engages with the stud 20 to fasten the trim element 1 to the mirror housing 2. However, while the screw 3 is engaged with the stud 21, the pressure for screwing the screw 3 is added to the cover 12. If the screw 3 is tightly screwed, the cover 12 may generate a pull force to the stud 21 and a decline may appear in the mirror housing 2 due to the pull force on the stud 21. The decline may cause poor appearance of the mirror housing 2.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a fastening structure assembly to fasten a trim to a mirror housing of a related art.

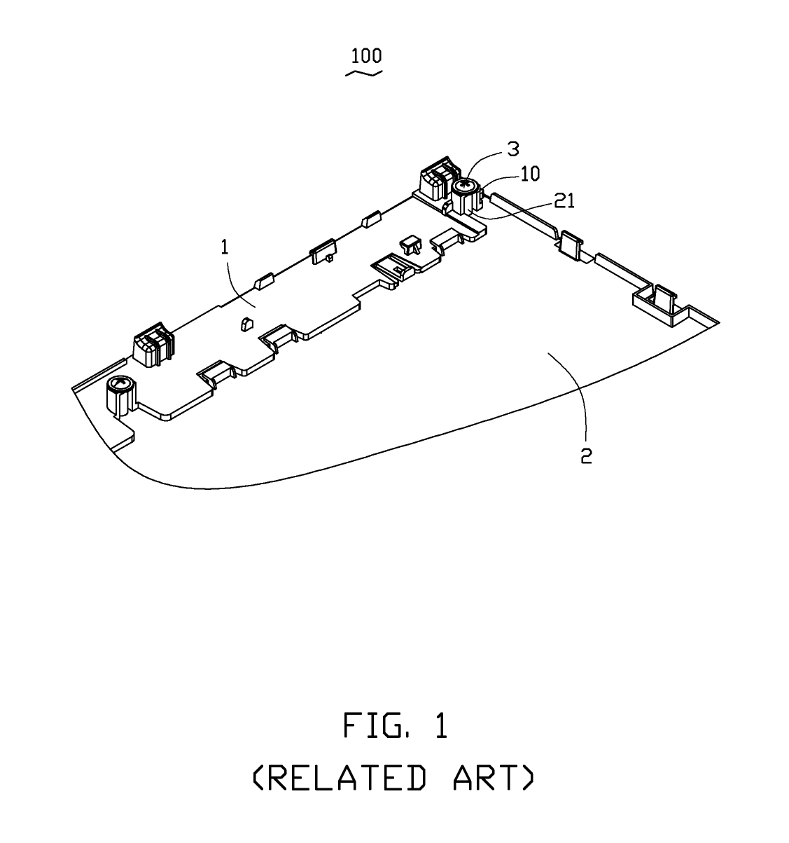

FIG. 2 is an explored view of the fastening structure assembly of FIG. 1.

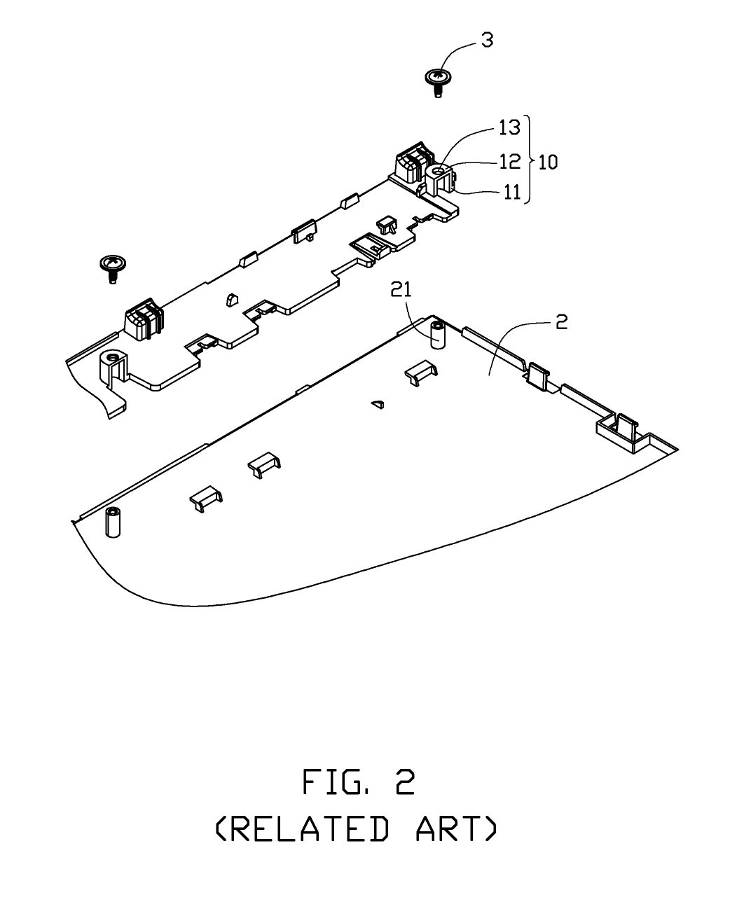

FIG. 3 is an isometric view of a fastening structure assembly to fasten a to-be-fastened element to a housing in accordance with an exemplary embodiment.

FIG. 4 is an explored view of the fastening structure assembly of FIG. 3.

### DETAILED DESCRIPTION

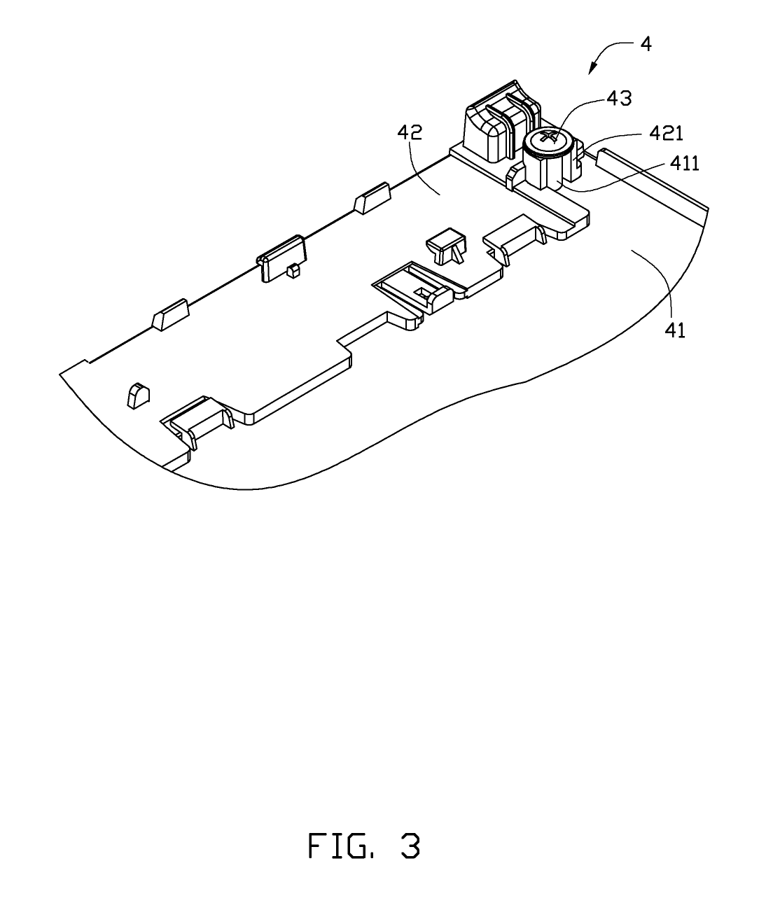

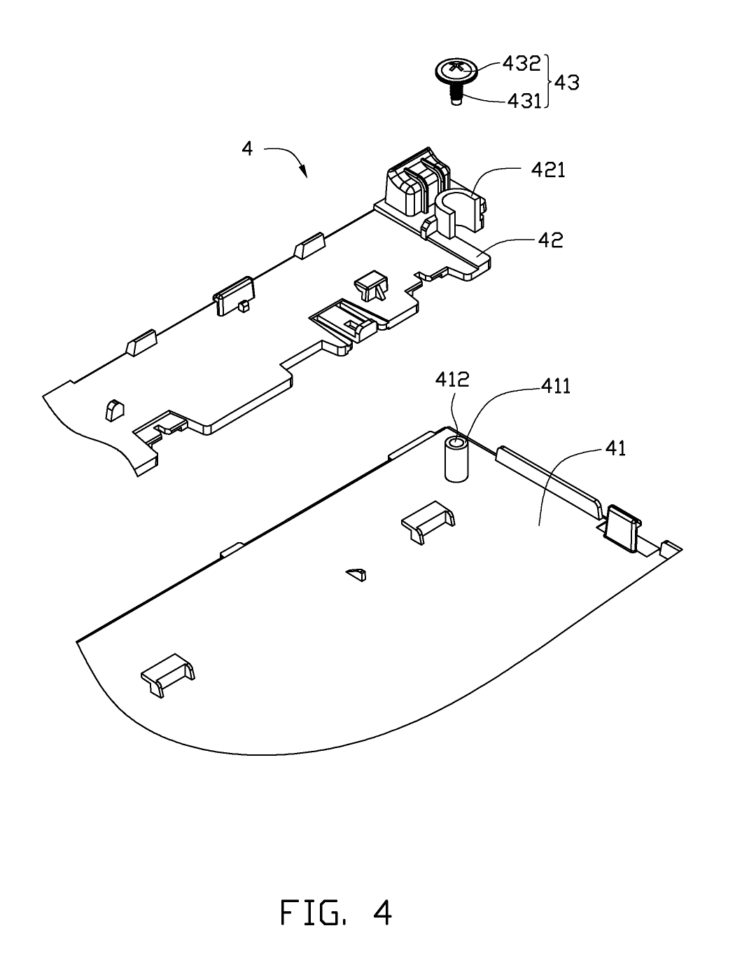

FIGS. 3 and 4 show a fastening structure assembly 4 including a housing 41, a to-be-fastened element 42 and at least one fastening element 43. The housing 41 defines at least one fastening post 411. The fastening element 43 includes a stopper 432 and a fastening pole 431. The fastening pole 431 extends from the stopper 432. The to-be-fastened element 42 includes at least one supporter 421 each of which is bent to surround the corresponding fastening post 411. Each fastening pole 431 engages with one fastening post 411 to make the stopper 432 resist the edge of the supporter 421, thereby the to-be-fastened element 42 is fastened to the housing 41.

In the embodiment, the fastening element 43 is a screw and the fastening post 411 defines a screw hole 412. The fastening pole 32 of the fastening element 43 is screwed to the screw hole 412 to make the stopper 432 resist the supporter 421.

In the embodiment, the supporter is a panel, the housing 41 is a mirror housing, the to-be fastened element 42 is a trim.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A fastening structure assembly comprising:
a housing defining at least one fastening post;
a to-be-fixed element comprising at least one supporter each of which is bent to surround one of the at least one fastening post; and
at least one fastening element, each of which comprises a stopper and a fastening pole extending from the stopper;
wherein each of the at least one fastening pole engages with one of the at least one fastening post to make the corresponding stopper resist an edge of the supporter surrounding the fastening post to fasten the to-be-fixed element to the housing.

2. The fastening structure assembly as described in claim 1, wherein the at least one fastening element is a screw and each of the at least one fastening post defines a screw hole, each of the at least one fastening pole of the fastening element is screwed to the screw hole of the corresponding post to make the stopper to resist the supporter.

3. The fastening structure assembly as described in claim 1, wherein the at least one supporter is a panel.

4. The fastening structure assembly as described in claim 1, wherein, the housing is an mirror housing and the to-be fixed element is a trim.
